(19) United States
(12) Patent Application Publication
(10) Pub. No.: US 2025/0159341 A1
(43) Pub. Date: May 15, 2025

(54) METHOD OF OPERATING IMAGING APPARATUS FOR LOADING REDUCTION

(71) Applicant: MEDIATEK INC., Hsinchu City (TW)

(72) Inventors: Chi-Cheng Ju, Hsinchu City (TW); Yan-Shao Liu, Hsinchu City (TW); Yu-Chang Huang, Hsinchu City (TW); Yu-En Wu, Hsinchu City (TW)

(73) Assignee: MEDIATEK INC., Hsinchu City (TW)

(21) Appl. No.: 18/940,859

(22) Filed: Nov. 8, 2024

Related U.S. Application Data
(60) Provisional application No. 63/597,716, filed on Nov. 10, 2023.

(51) Int. Cl. H04N 23/60; H04N 7/035; H04N 23/90

(52) U.S. Cl. CPC H04N 23/665; H04N 7/0352; H04N 23/90

(57) ABSTRACT

A method of operating an imaging apparatus includes generating combined sensor settings for a plurality of image sensors by an image signal processor (ISP), and transmitting the combined sensor settings from the ISP in a single operation. The ISP includes a single software flow control for the plurality of image sensors. The method significantly optimizes CPU usage and reduces power consumption in multi-sensor camera systems. By consolidating multiple software and data control flows into a single, unified process, the system achieves a substantial reduction in computational overhead.

### CROSS REFERENCE TO RELATED APPLICATIONS

This application claims the benefit of U.S. Provisional Application No. 63/597,716, filed on Nov. 10, 2023. The content of the application is incorporated herein by reference.

### BACKGROUND

In recent years, the use of multiple image sensors in various electronic devices, particularly in automotive applications, has become increasingly common. Advanced driver-assistance systems (ADAS), autonomous vehicles, and features like surround-view cameras and sentry modes rely on multiple cameras to provide comprehensive visual information. For instance, electric vehicles may employ numerous image sensors that are constantly active throughout the day to monitor the vehicle's surroundings.

However, the integration and control of multiple image sensors present significant challenges in terms of computational resources and power consumption. The high CPU loading associated with controlling multiple sensors presents several significant drawbacks in multi-sensor systems. It leads to increased power consumption, which is particularly critical in electric vehicles where it can negatively impact driving range. This heightened computational activity also results in greater heat generation, necessitating more robust and potentially costly cooling solutions. Moreover, the intensive processing requirements can create performance bottlenecks, limiting the system's ability to process sensor data in real-time, which is crucial for applications like autonomous driving and advanced driver-assistance systems.

To meet these demanding computational needs, more powerful and expensive processors may be required, driving up the overall hardware costs of the system. As automotive and other multi-sensor applications continue to evolve, there is a pressing need for more efficient methods to manage and control multiple image sensors without incurring prohibitive computational costs.

### SUMMARY

An embodiment provides a method of operating an imaging apparatus. The method comprises generating combined sensor settings for a plurality of image sensors by an image signal processor (ISP), and transmitting the combined sensor settings from the ISP in a single operation. The ISP comprises a single software flow control for the plurality of image sensors.

An embodiment provides an apparatus comprising one or more processors. The one or more processor is used to generate combined sensor settings for a plurality of image sensors, and transmit the combined sensor settings in a single operation. The one or more processors comprise a single software flow control for the plurality of image sensors.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts a flow control process for a camera sensor system according to the embodiments.

FIG. 2 depicts a related flow control process for a camera sensor system.

FIG. 3 depicts a grouped flow control process for a camera sensor system according to the embodiments.

FIG. 4 depicts a flow control process for a camera sensor system according to the embodiments.

FIG. 5 depicts a related flow control process for a camera sensor system.

FIG. 6 depicts a schematic representation of a method for managing image buffers in a camera sensor system.

FIG. 7 depicts a method for managing multiple image buffers in a camera sensor system according to the embodiments.

FIG. 8 depicts a flow control process for a camera sensor system according to the embodiments.

FIG. 9 depicts a flow control process for another camera sensor system according to the embodiments.

FIG. 10 depicts a flow control process for another camera sensor system according to the embodiments.

### DETAILED DESCRIPTION

The present disclosure provides a detailed description of various embodiments. While specific implementation details are presented herein to facilitate a comprehensive understanding of the disclosure, it will be apparent to those skilled in the art that the present invention may be realized without necessarily adhering to all such particularities. In certain instances, well-established methods, procedures, components, and circuits have been omitted from exhaustive description to avoid obscuring the present disclosure. It should be understood that technical features individually described in relation to a single drawing may be implemented either discretely or in combination with other features, as set forth in the present specification.

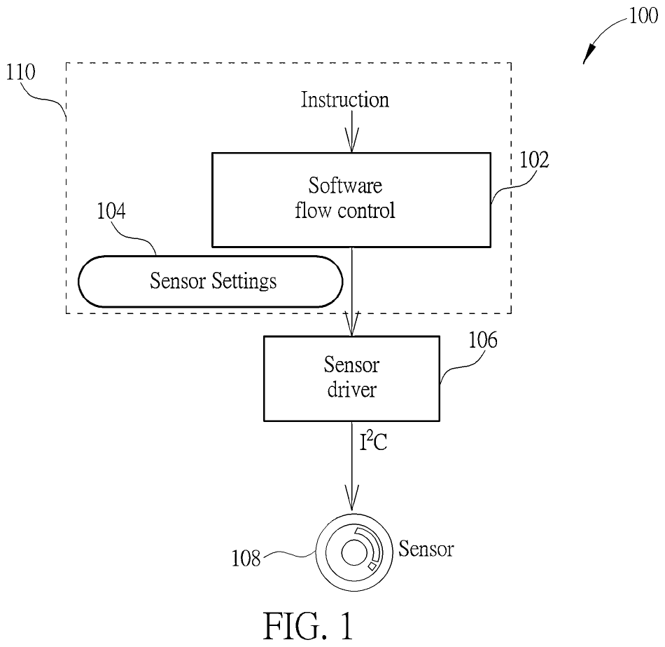

FIG. 1 depicts a flow control process for a camera sensor system 100 according to the embodiments. At the top of the figure, a software flow control block 102 represents the control mechanism for at least part of the camera sensor system 100. It can receive instructions for setting an image sensor 108 from imaging software modules. Sensor settings 104 represent various control parameters and settings for the image sensor 108. Sensor driver 106 is an intermediary component between the software flow control 102 and the image sensor 108. It receives sensor settings 104 from the software flow control 102 and translates/convert them into commands for the image sensor 108. The sensor driver 106 can communicate with the image sensor 108 via communication protocols such as I²C or I³C protocol.

In certain implementations, the software flow control block 102 can directly receive sensor settings 104 from imaging software modules instead of separate instructions.

The image sensor 108 can be a CMOS (Complementary Metal Oxide Semiconductor) or CCD (Charge Coupled Device) type sensor. It can be used in applications like rearview cameras, surround view systems, lane departure warnings, adaptive cruise control, and automatic emergency braking. The image sensor 108 can also be equipped with high dynamic range (HDR) for clear images in varying light conditions, LED flicker mitigation, and high resolution for precise object detection. Furthermore, the image signal processor (ISP) 110 is represented by the dotted box, which may include software flow control block 102 and sensor setting 104, and potentially other software modules.

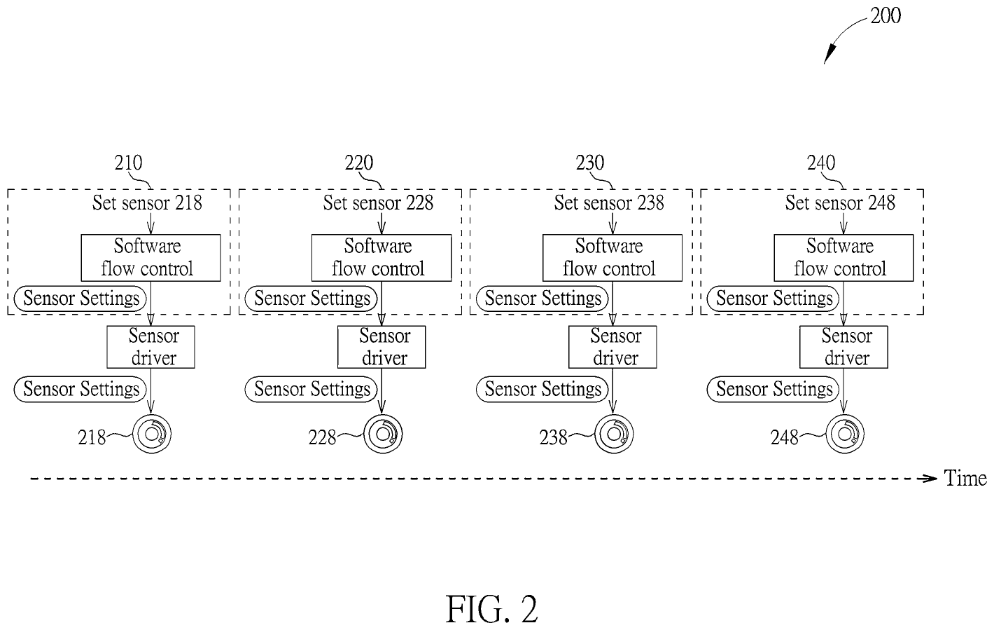

FIG. 2 depicts a related flow control process for a camera sensor system 200. Based on the flow control illustrated in FIG. 1, the flow control process in FIG. 2 is shown in four sections, each representing the control process corresponding to an individual image sensor. Each dotted box represents an ISP, i.e., ISP 210, ISP 220, ISP 230 and ISP 240. In certain embodiments, it may represent a single ISP performing the process four times. The time arrow indicates time progress, which may represent consecutive frames or time periods in the camera operation.

Within each section, a software flow control block is used to manage the control flow for its respective image sensor independently. A sensor driver between the image sensor and the software flow control block functions as an interface between the software components and the image sensor hardware.

The key aspect is the repetition of the same control structure across all time segments with the related approach. This illustration represents a system where each image sensor is controlled independently, with its own software flow control, sensor settings generation, and data path through the sensor driver to the image sensor. This approach, while providing fine-grained control, can lead to increased CPU usage and reduced efficiency when dealing with multiple sensors, as each sensor requires its own processing cycle and control flow.

In a related approach with m sensors (e.g., m=4), there are m separate software control flows and m separate data control flows. Each software control flow consumes n MCPS (Million Clock-cycles Per Second) of CPU loading, while each data control flow consumes k MCPS. As a result, the total CPU loading for the related approach is mx(n+k) MCPS. This means that as the number of sensors increases, the CPU loading grows linearly, potentially leading to significant computational overhead and power consumption when dealing with multiple image sensors.

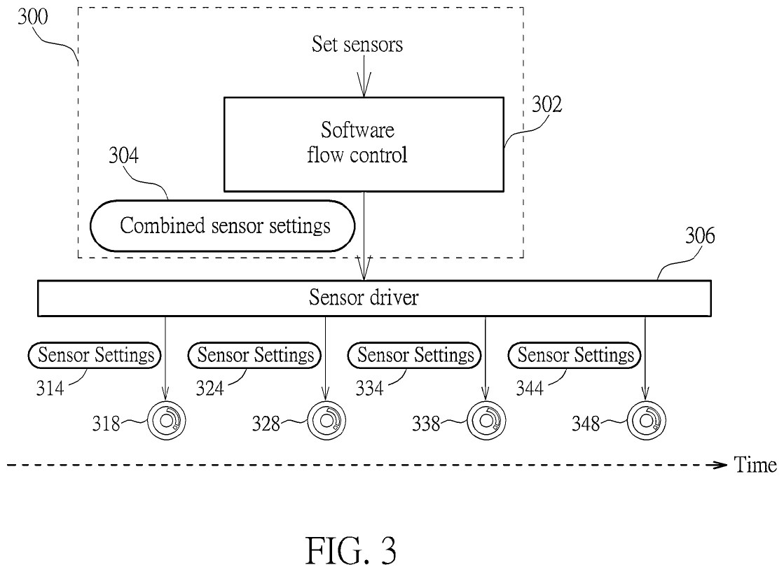

FIG. 3 depicts a grouped flow control process for a camera sensor system 300 according to the embodiments. At the top of the figure, a single software flow control block 302 can be implemented to receive instructions for setting image sensors 318, 328, 338 and 348 concurrently. The output from this consolidated control mechanism is represented by the combined sensor settings 304, which encapsulates configuration data for the image sensors 318, 328, 338 and 348 in a single package.

It should be noted that the image sensors 318, 328, 338, and 348 are characterized by identical operational parameters. Specifically, these sensors share the same sensor latch timing, vertical synchronization (VSYNC) timing, and frame rate. This uniformity in timing characteristics is a crucial prerequisite for the implementation of the illustrated grouping control method. In some other embodiments, there may be addition image sensors with at least one operational parameter different from the image sensors 318, 328, 338, and 348, which should not be limited in this disclosure.

The combined sensor settings 304 are then transmitted to a single sensor driver 306, which is tasked with the management of the image sensors 318, 328, 338 and 348, effectively replacing the need for individual drivers for each image sensor. Within the sensor driver, the combined settings are disaggregated into individual sensor settings 314, 324, 334 and 344 for each respective image sensor.

Then, each image sensor 318, 328, 338 and 348 can receive its specific sensor settings (i.e., sensor settings 314, 324, 334 and 344) from the sensor driver 306. A time arrow indicates that this process occurs over time, but in a single flow rather than separate cycles for each sensor. It should be noted that the sensor driver 306 can communicate with the image sensors 318, 328, 338, and 348 via communication protocols such as I²C or I³C protocol.

The key feature of this approach is the consolidation of control and data flows for multiple sensors, aimed at reducing CPU loading and improving efficiency. This optimized approach is distinguished from related methods by its use of a single software flow control for all sensors, the combination of settings for all sensors into one package, the utilization of a single sensor driver to manage all sensors, and the distribution of individual settings to each sensor from the centralized driver. Through this method, it is anticipated that CPU loading can be significantly reduced, potentially decreasing from m×(n+k) MCPS to 1×(n+k) MCPS, where m represents the number of sensors, n denotes the CPU loading for software control, and k signifies the CPU loading for data control.

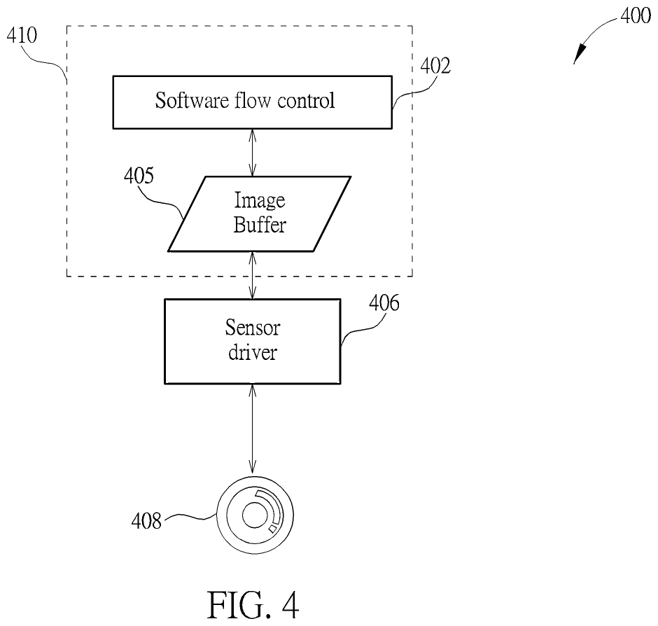

FIG. 4 depicts a flow control process for a camera sensor system 400 according to the embodiments. At the top of the figure, a software flow control block 402 represents the overall control mechanism for the camera sensor system 400. It can send and/or receive data from a sensor driver 406. An image buffer 405 between the software flow control block 402 and the sensor driver 406 serves as temporary storage for data (e.g., image data, sensor setting, etc.), allowing for efficient handling of data between the hardware sensor and the software components. The sensor driver 406 is an intermediary component between the software components and the image sensor 408, allowing the higher-level software to interact with the sensor hardware without needing to know the specific details of the image sensor 408. The sensor driver 406 may also manage the flow of image data from the image sensor 408 to the image buffer 405, including handling raw data from the image sensor 408 and potentially performing initial processing or formatting. The sensor driver 406 can communicate with the image sensor 408 via communication protocols such as I²C or I³C protocol. Furthermore, the image signal processor (ISP) 410 is represented by the dotted box, encompassing the software flow control block 402 and image buffer 405, along with potentially other software modules.

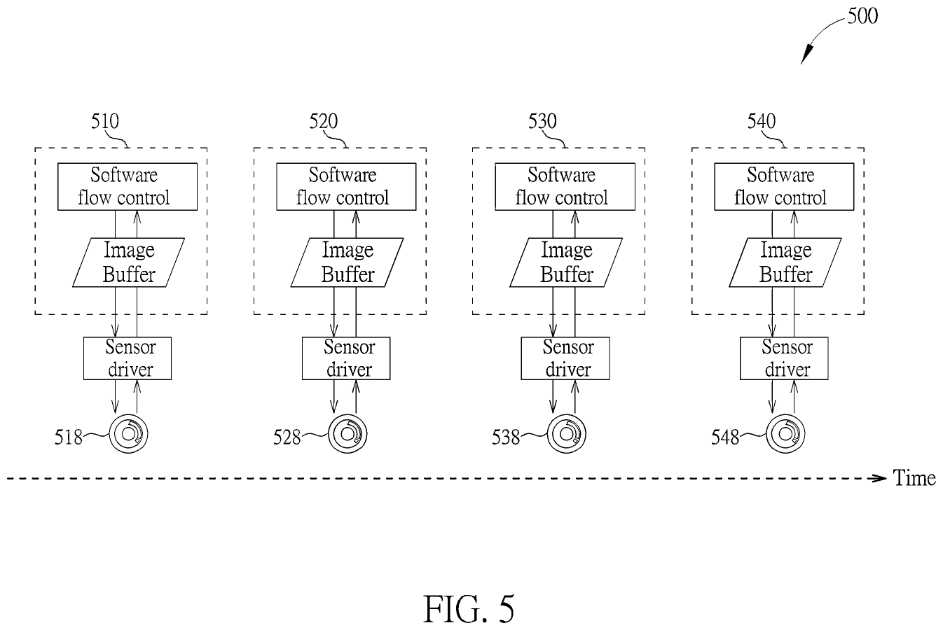

FIG. 5 depicts a related flow control process for a camera sensor system 500. Based on the flow control illustrated in FIG. 4, the flow control process in FIG. 5 is shown in four sections, each representing the control process corresponding to an individual image sensor. Each dotted box represents an ISP, i.e., ISP 510, ISP 520, ISP 530 and ISP 540. In certain embodiments, it may represent a single ISP performing the process four times. The time arrow indicates time progress from left to right across the figure representing consecutive frames or time periods in the camera operation.

Within each section, a software flow control block is used to manage the control flow for its respective image sensor independently (i.e., image sensor 518, 528, 538 or 548). An image buffer serves as a temporary storage for image data acquired from the corresponding image sensor. A sensor driver functions as an interface between the software components and the image sensor hardware. Bidirectional vertical arrows indicate data flow between the various components. The horizontal time arrow indicates time progress, which may represent consecutive frames or time periods in the camera operation.

The key aspect is the repetition of the same control structure across all time segments with the related approach. As illustrated, the system necessitates four independent data control flows to instruct four sensors to output data. Consequently, this approach incurs a computational cost of 4×k MCPS, where k represents the CPU loading for a single control flow. This compounding effect on CPU utilization is a direct result of managing each image sensor's data output individually.

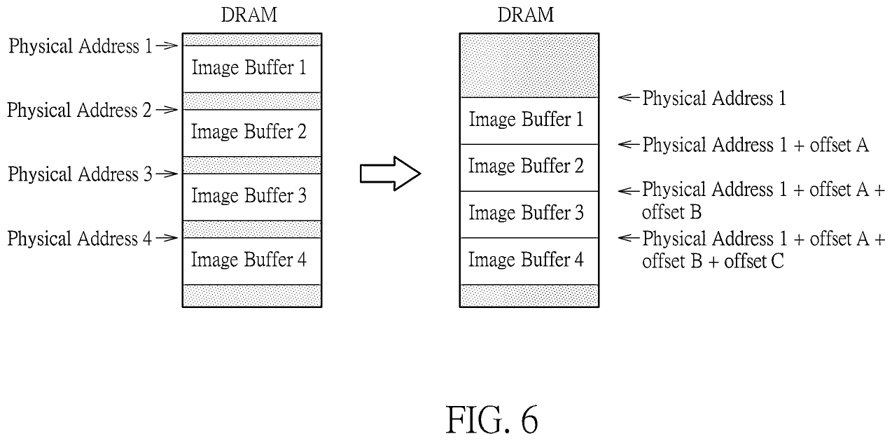

FIG. 6 depicts a schematic representation of a method for managing image buffers in a camera sensor system according to the embodiments. On the left side of FIG. 6, four separate image buffers (image buffer 1, 2, 3, and 4) in a dynamic random access memory (DRAM) are illustrated. Each buffer corresponds to an individual image sensor and has its own unique physical address. The image buffers are allocated independently in non-contiguous memory locations. On the right side, the same four image buffers are illustrated, but arranged contiguously in the DRAM based on another embodiment of this invention. All image buffers share a common base address (i.e., physical address 1). Subsequent buffers are accessed using offsets from the base address. That is, image buffer 2 starts at physical address 1+offset A; image buffer 3 starts at physical address 1+offset A+offset B; image buffer 4 starts at physical address 1+offset A+offset B+offset C.

The offsets A, B and C can be computed based on their respective image buffer sizes in the initialization phase (e.g., during system boot-up). Given that each sensor produces output images of predetermined dimensions, the calculation of these offsets are feasible within a contiguous physical buffer arrangement. This approach enables precise determination of buffer locations for each sensor within the unified memory structure, facilitating efficient access and management of image data throughout the system's operation. In some embodiments, each sensor has fixed output image size therefore even though it's a continuous physical buffer, offsets of sensor A/B/C/D still can be calculated.

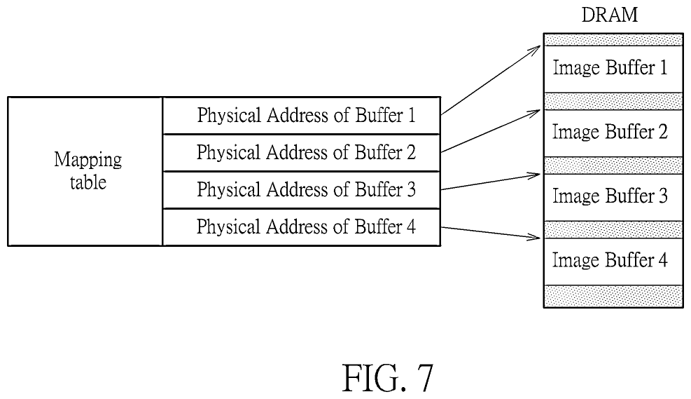

FIG. 7 depicts an alternative method for managing multiple image buffers in a camera sensor system according to the embodiments. This illustration shows a mapping table containing four entries, each corresponding to a specific image buffer. Each entry stores the physical address of its respective buffer in the DRAM. The DRAM contains four separate image buffers (i.e., image buffer 1, 2, 3, and 4). Each image buffer is allocated in non-contiguous memory locations. The arrows connecting the mapping table entries to the corresponding image buffers in DRAM represent the logical relationship between the stored addresses and the actual memory locations.

The mapping table provides a single data structure that describes the locations of all image buffers. This method allows the system to treat the separate buffers as a unified entity, potentially reducing the number of operations needed to manage multiple image sensors' data, while still maintaining the flexibility of independent buffer allocation in DRAM. In most cases, this approach necessitates only a single operational cost for setting or retrieving data from the sensor driver, thereby optimizing the efficiency of buffer management and data transfer processes.

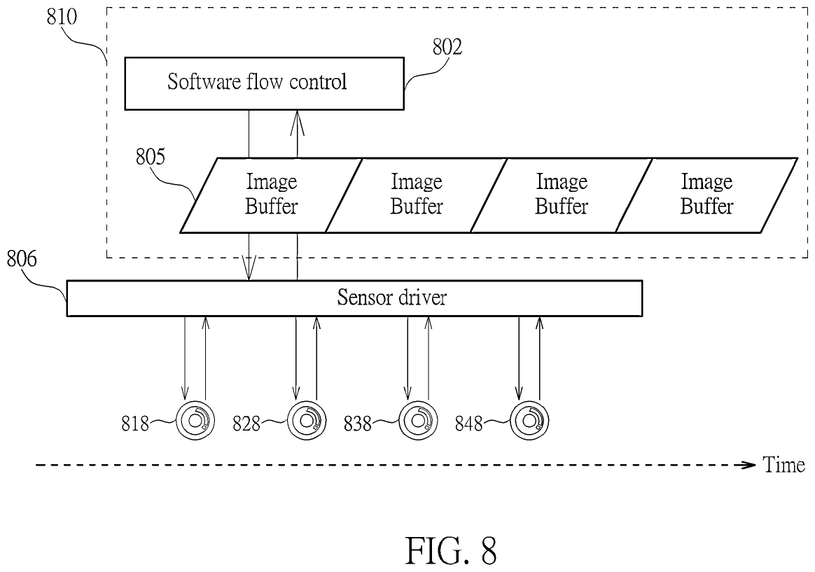

FIG. 8 depicts a flow control process for a camera sensor system 800 according to the embodiments. At the top of the figure, a single software flow control block 802 represents the overall control mechanism for the camera sensor system 800. It can send and/or receive data from a sensor driver 806. An unified (or grouped) image buffer 805 between the software flow control block 802 and the sensor driver 806 serves as temporary storage for data (e.g., image data, sensor setting, etc.), allowing for efficient handling of data between the hardware sensor and the software components. The sensor driver 806 is an intermediary component between the software components and the image sensors 818, 828, 838 and 848, allowing the higher-level software to interact with the sensor hardware without needing to know the specific details of the image sensors. The sensor driver 806 may also manage the flow of image data from the image sensors 818, 828, 838 and 848 to the image buffer 805, including handling raw data from the image sensor and potentially performing initial processing or formatting. The sensor driver 806 can communicate with the image sensors 818, 828, 838 and 848 via communication protocols such as I²C or I³C protocol. Furthermore, the image signal processor (ISP) 810 is represented by the dotted box, encompassing the software flow control block 402 and image buffer 405, along with potentially other software modules.

The image buffer 805 is a unified image buffer corresponding to all four image sensors 818, 828, 838 and 848, as illustrated in FIG. 6. In this optimized approach, the software flow control block 802 provides a single physical address to the sensor driver 806, which then use buffer size as an offset to four distinct image buffers. The sensor driver 806 is also responsible for instructing the image sensors 818, 828, 838 and 848 to output data to their respective buffer addresses in the image buffer 805, using the base physical address in conjunction with the calculated offsets. Furthermore, the sensor driver 806 collects all buffers addresses once all sensors readout are complete, returning the consolidated data in a single transaction. This buffer grouping strategy effectively reduces the data control flow from four separate operations to a single, unified process.

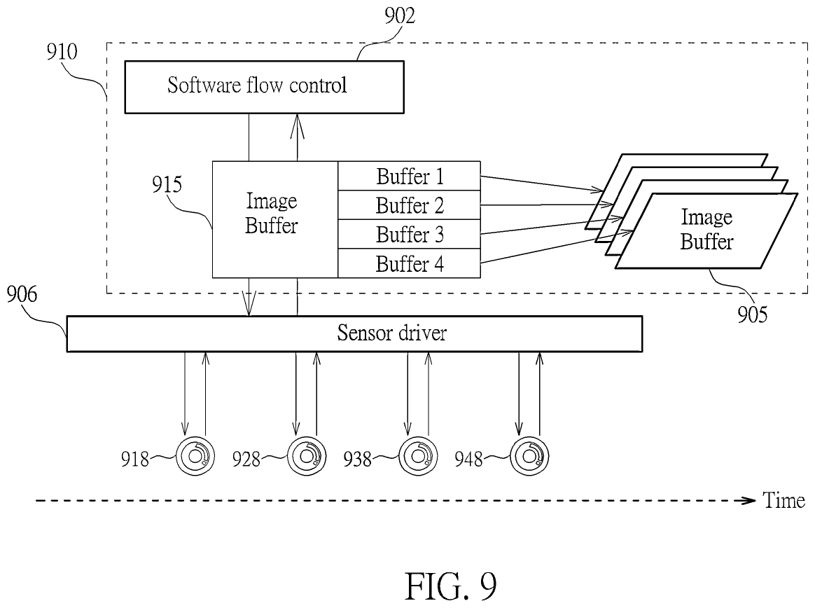

FIG. 9 depicts an alternative flow control process for a camera sensor system 900 according to the embodiments. The flow control process depicted in FIG. 9 closely resembles the one shown in FIG. 8. The difference is that a mapping table 915, as illustrated in FIG. 7, is used to describe the physical addresses of four distinct image buffers. The software flow control block 902 can a mapping table 915 in a form of software bundle. Then, the software flow control block 902 can send the software bundle to the sensor driver 906.

During the initialization stage (e.g., system boot-up), the software flow control block 902 determines the required image buffer sizes based on the known image dimensions from each sensor 918, 928, 938 and 948. The software flow control block 902 then allocates the necessary image buffers and obtains their corresponding physical addresses. These physical addresses are organized into a mapping table 915, which is packaged as a single software bundle by the software flow control block 902.

The software flow control block 902 transmits this software bundle containing the mapping table 915 to the sensor driver 906. Upon receiving the bundle, the sensor driver 906 can interpreting the mapping table 915 and configuring each image sensor 918, 928, 938 and 948 with its corresponding buffer address for data writing operations.

The sensor driver 906 aggregates data from all image sensors according to the address mappings provided in the mapping table 915. This approach maintains the efficiency of requiring only one control instruction to manage four image buffers, while allowing for flexible memory allocation.

This approach has the advantage of requiring only one control instruction to manage four image buffers. Further, the sensor driver 906 can directly use the physical addresses provided in the mapping table 915 to configure the images sensors 918, 928, 938 and 948. Finally, it consolidates what would be four separate operations into a single, efficient process. By implementing this method, the system reduces overhead and simplifies the management of multiple image buffers in a multi-sensor camera.

The implementation of either the physically contiguous memory allocation or the utilization of a mapping table to encapsulate four distinct physical addresses results in a significant reduction of CPU loading. This optimization effectively decreases the computational burden from 4 k MCPS to 1 k MCPS, where k represents the CPU loading for each data control flow operation. Such an approach substantially enhances system efficiency by consolidating multiple memory management operations to a single, operation.

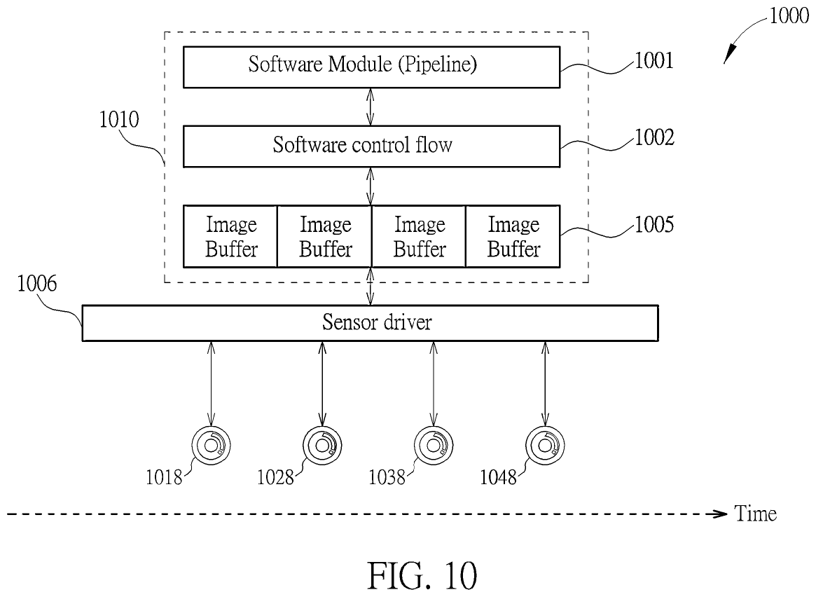

FIG. 10 depicts a flow control process for a camera sensor system 1000 according to the embodiments. In this optimized configuration, the settings and data flows are streamlined. The software module 1001 initiates combined sensor settings for images sensors 1018, 1028, 1038 and 1048. The combined sensor settings are passed to a single software control flow block 1002 and sent to the sensor driver 1006 in one operation. The sensor driver 106 interprets the combined sensor settings and distributes the appropriate configurations to each of the image sensors 1018, 1028, 1038 and 1048.

Then, the image sensors 1018, 1028, 1038 and 1048 capture image data. The data is sent to the sensor driver 1006. Next, the sensor driver 1006 manages the incoming data from the images sensors 1018, 1028, 1038 and 1048 and writes it to the appropriate sections of the image buffer 1005. The data transfer between the image buffer and the software control flow block 1002 may occur in a single operation. The software control flow block 1002 can then process or forward this data as needed to the software module 1001 for further processing.

Thus, by leveraging specific conditions-identical latch timing, synchronized VSYNC timing, and uniform frame rates (FPS) across image sensors—the optimized approach enables the consolidation of m distinct software and data control flows into a single unified flow. This optimization results in a significant reduction of CPU loading, decreasing it from m×(n+k) MCPS to 1×(n+k) MCPS. In this context, m represents the number of image sensors, n represents the CPU loading for software control operations, and k represents the CPU loading for data control operations. This approach substantially enhances system efficiency by minimizing computational overhead in multi-sensor camera systems.

As an example, in Linux-based systems, which have distinct kernel and user space domains, the ioctl API serves as an interface between these two spaces. Relatedly, kernel space drivers are responsible for configuring hardware settings. This method to group multiple sensor configurations (along with related peripheral components like Image Signal Processors or ISPs) into a single unit can reduce the number of ioctl invocations from N to 1. Consider a scenario where data structures like sensor_setting and isp_setting are used to describe hardware configurations for sensors and ISPs, respectively. In a related software design, controlling N sensors would require N separate ioctl calls. This invention combines these N settings into a single package, allowing for just one ioctl invocation. This approach significantly reduces software overhead associated with multiple ioctl calls, provided certain pre-conditions are met (such as shared VSYNC signal, identical sensor latch time, and consistent FPS across sensors).

An example of the pseudo code is shown below:

```
struct sensor_setting {
  _u32 shutter_speed;
  _u32 sensor_gain;
  _u32 frame_length;
...
  _u32_reserved[32];
};
struct isp_setting {
  _u32 registerA;
  _u32 registerB;
  _u32 registerC;
...
  _u32 registerZZ;
};
```

The following pseudo code shows the control flow of the related method (One data structure for one sensor/ISP hardware, N=4):

```
struct related_method {
    struct sensor_setting sensor_settings;
    struct isp_setting isp_settings;
...
};
for (int i = 0; i < 4; ++i) {
  int result = 0;
  struct related_method s = { };
  s = get_trad_settings(i); // assume get i-th sensor settings
  ioctl(fd, CMD_SET_SETTINGS, &s); // ioctl to set settings to driver
}
```

The following pseudo code shows the control flow according to the embodiments:

```
struct this_invention {
  struct sensor_setting sensor_settings[4];
  struct isp_setting isp_settings[4];
...
};
int result = 0;
struct this_invention s = { };
s = get_all_settings( ); // assume get i-th sensor settings
ioctl(fd, CMD_SET_SETTINGS, &s); // ioctl to set settings to driver
once
```

The various embodiments of the present disclosure provide an method of operating a camera system to significantly optimize CPU usage and reduce power consumption in multi-sensor camera systems. By consolidating multiple software and data control flows into a single, unified process, the system achieves a substantial reduction in computational overhead. One of the key benefits is the dramatic decrease in CPU loading. In related architectures, each sensor requires its own software and data control flow, resulting in a CPU load of m×(n+k) MCPS, where m is the number of image sensors, n is the CPU load for software control, and k is the CPU load for data control. The disclosed approach reduces it to just 1×(n+k) MCPS, representing a considerable efficiency gain, especially in systems with numerous sensors.

The optimization is achieved through clever grouping of sensor operations based on shared characteristics such as latch timing, VSYNC timing, and frame rates. This approach allows for the unified management of multiple sensors without sacrificing individual sensor control. Furthermore, the invention introduces innovative methods for handling image buffers, either through physically contiguous memory allocation or a mapping table, further streamlining data management and reducing CPU load.

Another significant advantage is the potential for improved power efficiency. By reducing the computational overhead, the system can operate with lower power consumption, which is particularly crucial in battery-powered devices or electric vehicles where energy management is a critical concern.

Finally, the simplified architecture resulting from this disclosure may lead to reduced system complexity, easier maintenance, and improved scalability. As the number of sensors in a system increases, the benefits of this approach become even more pronounced, making it particularly valuable in advanced multi-sensor applications like autonomous vehicles or sophisticated surveillance systems.

The terminology employed in the description of the various embodiments herein is intended for the purpose of describing particular embodiments and should not be construed as limiting. In the context of this description and the appended claims, the singular forms “a”, “an”, and “the” are intended to encompass plural forms as well, unless the context clearly indicates otherwise.

It should be understood that the term “and/or” as used herein is intended to encompass any and all possible combinations of one or more of the associated listed items. Furthermore, it should be noted that the terms “includes,” “including,” “comprises,” and/or “comprising,” when used in this specification, indicate the presence of stated features, integers, steps, operations, elements, and/or components, but do not exclude the presence or addition of one or more other features, integers, steps, operations, elements, components, and/or groups thereof.

The use of ordinal designators like “first,” “second,” and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

Unless specifically stated otherwise, the term “some” refers to one or more. Various combinations using “at least one of” or “one or more of” followed by a list (e.g., A, B, or C) should be interpreted to include any combination of the listed items, including individual items and multiple items.

Terms such as “coupled,” “connected,” “connecting,” and “electrically connected” are used synonymously to describe a state linked together through physical wires or wireless of being connections to enable electrical or electronic communications. When an entity is described as being in “communication” with another entity or entities, it implies the capability of sending and/or receiving electrical signals, which may contain data/control information, regardless of whether these signals are analog or digital in nature.

This interpretation of terminology is provided to ensure clarity and consistency throughout the specification and claims, and should not be construed as restricting the scope of the disclosed embodiments or the appended claims.

The various illustrative components, logic, logical blocks, modules, circuits, operations and algorithm processes described in connection with the embodiments disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus utilized to implement the various illustrative components, logics, logical blocks, modules, and circuits described herein may comprise, without limitation, one or more of the following: a general-purpose single-chip or multi-chip processor, a graphics processing unit (GPU), a tensor processing unit (TPU), a neural network processing unit (NPU), a digital signal processor (DSP), an application specific integrated circuit (ASIC), a field programmable gate array (FPGA), other programmable logic devices (PLDs), discrete gate or transistor logic, discrete hardware components, any suitable combination thereof. Such hardware and apparatus shall be configured to perform the functions described herein.

A general-purpose processor may include, but is not limited to, a central processing unit (CPU), a microprocessor, or alternatively, any related processor, controller, microcontroller or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

It is to be understood that in some embodiments, particular processes, operations, or methods may be executed by circuitry specifically designed for a given function. Such function-specific circuitry may be optimized to enhance performance, efficiency, or other relevant metrics for the particular task at hand. The selection of specific hardware implementation shall be determined based on the particular requirements of the application, which may include, inter alia, performance specifications, power consumption constraints, cost considerations, and size limitations.

In certain aspects, the subject matter described herein may be implemented as software. Specifically, various functions of the disclosed components, or steps of the methods, operations, processes, or algorithms described herein, may be realized as one or more modules within one or more computer programs. These computer programs may comprise non-transitory processor-executable or computer-executable instructions, encoded on one or more tangible processor-readable or computer-readable storage media. Such instructions are configured for execution by, or to control the operation of, data processing apparatus, including the components of the devices described herein. The aforementioned storage media may include, but are not limited to, RAM, ROM, EEPROM, CD-ROM or other optical disk storage, magnetic disk storage or other magnetic storage devices, or any other medium capable of storing program code in the form of instructions or data structures. It should be understood that combinations of the above-mentioned storage media are also contemplated within the scope of computer-readable storage media for the purposes of this disclosure.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure, the principles and the novel features disclosed herein.

In certain implementations, the embodiments may comprise the disclosed features and may optionally include additional features not explicitly described herein. Conversely, alternative implementations may be characterized by the substantial or complete absence of non-disclosed elements. For the avoidance of doubt, it should be understood that in some embodiments, non-disclosed elements may be intentionally omitted, either partially or entirely, without departing from the scope of the invention. Such omissions of non-disclosed elements shall not be construed as limiting the breadth of the claimed subject matter, provided that the explicitly disclosed features are present in the embodiment.

Additionally, various features that are described in this specification in the context of separate embodiments also can be implemented in combination in a single implementation. Conversely, various features that are described in the context of a single implementation also can be implemented in multiple embodiments separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The depiction of operations in a particular sequence in the drawings should not be construed as a requirement for strict adherence to that order in practice, nor should it imply that all illustrated operations must be performed to achieve the desired results. The schematic flow diagrams may represent example processes, but it should be understood that additional, unillustrated operations may be incorporated at various points within the depicted sequence. Such additional operations may occur before, after, simultaneously with, or between any of the illustrated operations.

Additionally, it should be understood that the various figures and component diagrams presented and discussed within this document are provided for illustrative purposes only and are not drawn to scale. These visual are representations intended to facilitate understanding of the described embodiments and should not be construed as precise technical drawings or limiting the scope of the invention to the specific arrangements depicted.

In certain implementations, multitasking and parallel processing may prove advantageous. Furthermore, while various system components are described as separate entities in some embodiments, this separation should not be interpreted as mandatory for all embodiments. It is contemplated that the described program components and systems may be integrated into a single software package or distributed across multiple software packages, as dictated by the specific implementation requirements.

It should be noted that other embodiments, beyond those explicitly described, fall within the scope of the appended claims. The actions specified in the claims may, in some instances, be performed in an order different from that in which they are presented, while still achieving the desired outcomes. This flexibility in execution order is an inherent aspect of the claimed processes and should be considered within the scope of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of operating an imaging apparatus, comprising:
generating, by an image signal processor (ISP), combined sensor settings for a plurality of image sensors, the ISP comprising a single software flow control for the plurality of image sensors; and
transmitting the combined sensor settings from the ISP in a single operation.

2. The method of claim 1, wherein the plurality of image sensors have identical sensor latch timing, identical vertical synchronization (VSYNC) timing, or identical frame rate.

3. The method of claim 1, wherein the combined sensor settings comprise sensor settings for each of the plurality of image sensors.

4. The method of claim 3, further comprising controlling each of the plurality of image sensors using a sensor driver according to the corresponding sensor setting within the combined sensor settings.

5. The method of claim 1, further comprising receiving, by the ISP, image data generated by the plurality of image sensors according to the combined sensor settings in a single operation.

6. The method of claim 1, wherein the ISP comprises a single image buffer having continuous physical addresses.

7. The method of claim 6, further comprising receiving, by the single image buffer, image data generated by the plurality of image sensors according to the combined sensor settings in a single operation.

8. The method of claim 1, wherein a mapping table for mapping physical addresses of an image buffer associated with each of the plurality of image sensors to a single data structure is stored in the ISP.

9. An apparatus comprising one or more processors configured to:
generate combined sensor settings for a plurality of image sensors; and
transmit the combined sensor settings in a single operation;
wherein the one or more processors comprise a single software flow control for the plurality of image sensors.

10. The apparatus of claim 9, wherein the plurality of image sensors have identical sensor latch timing, identical vertical synchronization (VSYNC) timing, or identical frame rate.

11. The apparatus of claim 9, wherein the combined sensor settings comprise sensor settings for each of the plurality of image sensors.

12. The apparatus of claim 11, wherein each of the plurality of image sensors is controlled by a sensor driver according to the corresponding sensor settings within the combined sensor settings.

13. The apparatus of claim 9, wherein the one or more processors receive image data generated by the plurality of image sensors according to the combined sensor settings in a single operation.

14. The apparatus of claim 9, wherein the one or more processors comprise a single image buffer having continuous physical addresses.

15. The apparatus of claim 14, wherein the single image buffer receives image data generated by the plurality of image sensors according to the combined sensor settings in a single operation.
